(19) United States
(12) Patent Application Publication
(10) Pub. No.: US 2018/0094103 A1
(43) Pub. Date: Apr. 5, 2018

(54) POLYAMIDE POWDER FOR SELECTIVE SINTERING METHODS

(71) Applicant: Evonik Degussa GmbH, Essen (DE)

(72) Inventors: Wolfgang Diekmann, Waltrop (DE); Maik Grebe, Bochum (DE); Franz-Erich Baumann, Duelmen (DE); Sylvia Monsheimer, Haltern am See (DE); Beatrice Kueting, Marl (DE)

(73) Assignee: Evonik Degussa GmbH, Essen (DE)

(21) Appl. No.: 15/718,069

(22) Filed: Sep. 28, 2017

(30) Foreign Application Priority Data
Sep. 30, 2016 (DE) 102016219082.2

(51) Int. Cl. C08G 69/14; B29C 64/153; B33Y 10/00; B33Y 70/00; B33Y 80/00

(52) U.S. Cl. CPC C08G 69/14; B29C 64/153; B29K 2077/00; B33Y 70/00; B33Y 80/00; B33Y 10/00

(57) ABSTRACT

A polyamide powder for powder bed fusion methods is described. The polymer exhibits a solution viscosity to ISO 307 of 1.55 to 1.75 and an increase in solution viscosity of 10% to 40%, preferably 20% to 30%, when under a nitrogen atmosphere it is subjected to a temperature 10° C. below its melting temperature for 24 h.

### BACKGROUND OF THE INVENTION

### Field of the Invention

The present invention relates to polyamide powders for use in powder bed fusion methods and to the use thereof. The invention further relates to shaped bodies and to the production thereof.

### Description of the Related Art

Additive manufacturing methods, frequently also referred to as rapid prototyping, are used in order to be able to quickly and inexpensively manufacture three-dimensional objects. This manufacturing is effected directly on the basis of the in-computer data models from shapeless (liquids, powders or the like) or shape-neutral (in ribbon or wire form) material by means of chemical and/or physical processes. Polymer powders in particular, such as polyamide powder, are suitable as shapeless material.

Powder bed fusion technology includes, among other techniques, direct metal laser sintering (DMLS), electron beam melting (EBM), selective heat sintering (SHS), selective laser melting (SLM), selective laser sintering (SLS), selective absorbing sintering (SAS) and selective inhibition sintering (SIS).

As a result of the use of the polyamide powder in shaped body production, which typically takes place 10 to 20 K below the melting temperature, ageing phenomena can occur. In this context, the amine and carboxylic acid end groups react with one another and cause extension of the polyamide chains. Reprocessing of the powder is no longer possible, and so the unprocessed powder has to be replaced.

During a construction operation the object being formed rests within the powder bed of unconsolidated powder surrounding it and is supported by said powder. As a result of this there are generally considerable amounts of unconsolidated powder present after termination of a construction operation and it is therefore desirable as far as possible to use this so-called recycled powder for a further construction operation. However, during a construction operation the unused powder is exposed over lengthy periods to high temperatures scarcely below its melting temperature, thus resulting in the problem that these environmental conditions can cause the powder to undergo an aging process where it suffers thermal and/or thermooxidative damage. In addition, a chain extension and consequently a molecular weight increase can occur. As a result, for further construction operations the recycled powder needs to be mixed with virgin powder.

EP 2368696 A1 (US 2011/237731 A1) describes polyamide 12 powder, which can be employed in powder bed fusion methods. The powder is a mixture of two different polyamides 12. The first polyamide 12 exhibits an increase in the viscosity number to ISO of less than 10% while the second polyamide 12 is characterized by an increase in the viscosity number of 15% or more (under a nitrogen atmosphere for 20 hours in each case; the respective polyamides were subjected to a temperature 10° C. below their melting temperature). It is preferable when the proportion of the first polyamide 12 in the mixture with the second polyamide 12 is between 10 and 30 weight percent.

However, the use of a powder mixture consisting of two polyamides having different properties is disadvantageous. While the first polyamide exhibits a very small increase the second polyamide has a very large increase in viscosity. Over time this results in extreme inhomogeneities until finally the viscosity increase of the two polyamides diverges markedly. This results in shaped bodies produced by powder bed fusion methods which have inhomogeneous and anisotropic mechanical properties. In addition, the shaped bodies can experience greater variance in their mechanical parameters, in particular in elongation at break.

### SUMMARY OF THE INVENTION

The problem addressed was accordingly that of providing a polyamide powder which can be used in powder bed fusion methods, wherein the polyamide powder and shaped articles produced therefrom shall exhibit homogenous properties. In addition, the unprocessed powder should be reusable. This can reduce costs and protect the environment. The obtained shaped bodies should exhibit constant and homogenous mechanical properties such as elongation at break, dimensional accuracy, sharp edges and process robustness.

Polyamide powders for powder bed fusion methods which do not exhibit the disadvantages of the prior art were accordingly found. The polyamides have a solution viscosity to ISO 307 of 1.55 to 1.75. In addition, the increase in the solution viscosity is 10% to 40%, preferably 20% to 30%, when under a nitrogen atmosphere the polyamide powder is subjected to a temperature 10° C. below its melting temperature for 24 h.

A temperature of 10° C. below the melting temperature under a nitrogen atmosphere for 24 h is a test condition which simulates real conditions that exist in a construction space for production of shaped bodies. This is intended to ensure comparability of different materials.

### DETAILED DESCRIPTION OF THE INVENTION

The problem was solved by a polyamide powder exhibiting only a slight and uniform increase in solution viscosity over the period of 24 h. It can therefore be reused repeatedly. Resulting shaped bodies exhibit homogenous, isotropic mechanical properties.

Solution viscosity is determined in a double determination according to ISO 307 using the following parameters: Schott AVS Pro, solvent: acidic m-cresol, volumetric method, dissolution temperature 100° C., dissolution time 2 h, polymer concentration 5 g/l, measurement temperature 25° C.

To determine the increase in solution viscosity, the powder is subjected to a temperature 10° C. below its melting temperature for 24 h under nitrogen. The solution viscosity of the respective powders is subsequently determined as specified above.

The melting temperature is determined by means of differential scanning calorimetry (DSC) to DIN 53765. The crucial parameter is the melting temperature in the first heating step. The heating and cooling rates are each 20 K/min. The measurements are effected by means of a DSC 7 from Perkin Elmer.

Preferably, the polyamide comprises either amine end groups in excess or carboxylic acid end groups in excess. The excess can be achieved through diamines or dicarboxylic acids, preferably dicarboxylic acids. In addition monoamines or monocarboxylic acids, preferably monocarboxylic acids, may be added. Based on the mass of the polyamide powder, the excess of one end group over the other end group is 20 to 60 mmol/kg.

The polyamide powder preferably absorbs 1000 pl to 30 000 pl of liquid per g of polyamide powder, preferably 3000 pl to 25 000 pl and more preferably 5000 pl to 20 000 pl.

In order to achieve better processability of the polyamide powder, it may be advantageous that additives are added. Additives of this kind may, for example, be free-flow aids. The polyamide powder particularly preferably comprises 0.05% to 5% by weight, preferably from 0.1% to 1% by weight, based on the total weight of the polyamide powder, of additives. Free-flow aids may, for example, be fumed silicas, stearates or other free-flow aids known from the literature, for example tricalciutn phosphate, calcium silicates, Al₂O₃, MgO, MgCO₃ or ZnO. Fumed silica is supplied, for example, under the Aerosil® brand name by Evonik Industries AG.

As well as or instead of such free-flow aids, some of which are inorganic, or other additives, the polyamide powder may also include inorganic filling materials. The use of such filling materials has the advantage that these essentially retain their shape through the treatment in the bonding operation and hence reduce shrinkage of the shaped body. Moreover, it is possible through the use of filling materials, for example, to alter the plastic and physical properties of the objects. Thus, through use of powder material including metal powder, both the transparency and colour and the magnetic or electrical properties of the object can be adjusted. As fillers or filling materials, the powder material may include, for example, glass particles, ceramic particles or metal particles. Typical fillers are, for example, metal granules, aluminium powder, steel shot or glass beads. Particular preference is given to using powder materials including glass beads as filling materials. In a preferred embodiment, the powder material according to the invention includes from 1% to 70% by weight, preferably from 5% to 50% by weight and most preferably from 10% to 40% by weight of filling materials, based on the total weight of the polyamide powder.

Suitable polyamides for the polyamide powder may be customary and known polyamides. Polyamides include homopolyamides and copolyamides. Suitable polyamides or copolyamides are selected from polyamide 6, 11, 12, 1013, 1012, 66, 46, 613, 106, 11/1010, 1212 and 12/1012. A preferred polyamide is selected from polyamide 11, 12, 1013, 1012, 66, 613, 11/1010, 1212, and 12/1012, particularly preferably polyamide 11 or 12 and very particularly preferably polyamide 12.

Typically, a polyamide powder which is used in sintering methods should have a minimum BET surface area. The prior art discloses that the value should, for example, be less than 7 m²/g. The polyamide powder according to the invention should have a BET surface area, measured to DIN ISO 9277, of at least 1 m²/g, preferably of at least 2.5 m²/g, particularly preferably of at least 5.5 m²/g, very particularly preferably of at least 7 m²/g, and in particular of 7.5 m²/g to 30 m²/g. A particularly preferred embodiment includes polyamides having a BET surface area of at least 7 m²/g, preferably of 7.5 m²/g to 30 m²/g. Measurement is effected with the Micromeritics TriStar 3000 instrument, nitrogen gas adsorption, discontinuous volumetric method, 7 data points at relative pressures P/P0 from about 0.05 to about 0.20, dead volume calibration using He (99.996%), sample preparation 1 h at 23° C.+16 h at 80° C. in vacuo, specific surface area based on devolatilized specimen, evaluation was effected by means of multipoint determination.

In a preferred embodiment, the polyamide powder has a cumulative pore volume distribution of at least 0.02 cm³/g and a BET surface area of at least 2.8 m²/g, preferably 0.04 cm³/g and 5.8 m²/g, more preferably 0.05 cm³/g and 10 m²/g and especially preferably of 0.07 cm³/g and 13 m²/g.

The weight-average particle diameter d₅₀ of the polyamide powder, measured by means of laser diffraction, should be preferably not more than 100 μm, preferably 10 μm to 80 μm (Malvern Mastersizer 3000; wet dispersion was effected in water, refractive index and blue light value fixed at 1.52; evaluation via Mie theory; dry measurement, 20-40 g of powder metered in by means of a Scirocco dry disperser; vibrating channel feed rate 70%, dispersion air pressure 3 bar; measurement time for the sample 5 seconds (5000 individual measurements)). Polymers having such diameters are also referred to as polymer powder.

It is advantageous when the polyamide powder with a particle diameter of less than 10.48 μm (ultrafine particles) is present in a small amount. The proportion of ultrafine particles should be less than 3% by weight, preferably less than 1.5% by weight and more preferably less than 0.75% by weight, based in each case on the total weight of polyamide powder. This reduces the evolution of dust and enables an improvement in processability. Ultrafine particles can be removed, for example, by means of sifting.

Preference is further given to polyamide powders having a bulk density, measured to DIN 53466, between 300 g/l and 600 g/l.

In addition, polyamides having a surface energy of not more than 35 mN/m, preferably from 25 mN/m to 32 mN/m, are preferred polyamides. The surface energy is determined by means of contact angle measurement by the capillary rise height method using the Washburn equation and the evaluation method according to Owens, Wendt, Rabel and Kaelble. Polyamide powders of this kind have very homogeneous flowability, which results in a high dimensional stability of the shaped bodies.

The polyamide powder and the composition thereof can be obtained by grinding the powder produced or by a precipitation process (reprecipitation), wherein the precipitation process is preferred.

In the precipitation process, the polyamide is at least partly dissolved at elevated temperature and then precipitated by reducing the temperature. Suitable solvents for polyamides are, for example, alcohols such as ethanol. U.S. Pat. No. 5,932,687 mentions suitable process conditions, for example. To establish the desired property, it is advantageous to leave the suspension obtained at a temperature 2-4 K above the precipitation temperature for 10 min to 180 min after the precipitation.

The invention further provides a method for production of the aforementioned polyamide powder. It comprises the polymerization and/or polycondensation of monomers to give a polyamide (step a) and powder production by grinding or reprecipitation (step b). In step a, either diamines to achieve an amine end group excess or dicarboxylic acids to achieve a carboxylic acid end group excess are added as chain transfer agents. The diamines/dicarboxylic acids are preferably added in a ratio such that an excess of one of the end groups over the other end group of 20 to 60 mmol/kg (based on the mass of the polyamide powder) results. In addition, monoamines or monocarboxylic acids may be employed.

Suitable monomers are, for example, monomers suitable for production of polyamides 6, 11, 12, 1013, 1012, 66, 46, 613, 106, 11/1010, 1212 and 12/1012.

Suitable monoamines and monocarboxylic acids for establishment of the excess of end groups preferably have the same number of carbon atoms as the monomers of the polyamides. Examples include butylamine, hexaneamine, decaneatnine and dodecaneamine and also caproic acid, capric acid, lauric acid, tridecanoic acid.

Suitable diamines and dicarboxylic acids for establishment of the excess of end groups may be the same as or different from the monomers of the polyamides. Examples include tetramethylenediamine, hexamethylenediamine, decanediamine, dodecanediamine, adipic acid, sebacic acid, dodecanoic acid, brassylic acid. It is preferable that the diamines or dicarboxylic acids have the same number of carbon atoms as the monomers of the polyamides.

In one embodiment of the invention, the polyamide can be obtained by coprecipitation. To this end in step a) at least one polyamide of the AB type, produced by polymerization of lactams having 4 to 14 carbon atoms in the monomer unit or by polycondensation of the corresponding w-aminocarboxylic acids having 4 to 14 carbon atoms in the monomer unit, and at least one polyamide of the AABB type, produced by polycondensation of diamines and dicarboxylic acids each having 4 to 14 carbon atoms in the monomer units, is obtained. In this case, the powder is obtained in step b) by coprecipitation of the at least one polyamide of the AB type and the at least one polyamide of the AABB type.

The invention further provides for the use of the polyamide powder according to the invention in powder bed fusion methods for production of shaped bodies.

In addition, shaped bodies which are obtained at least partly from polyamide powders according to the invention form a further part of the subject-matter of the invention. Furthermore, processes for production of shaped bodies by means of powder bed fusion methods wherein the polyamide powder according to the invention is used likewise form part of the subject-matter of the invention.

Having generally described this invention, a further understanding can be obtained by reference to certain specific examples which are provided herein for purposes of illustration only, and are not intended to be limiting unless otherwise specified.

### EXAMPLES

### Example 1

A nylon-12 was produced. As well as laurolactam as monomer, dodecanoic acid was used in order to obtain an excess of dicarboxylic acid end groups. The powder was obtained by means of a precipitation process.

### Example 2

A nylon-12 was produced. As well as laurolactam as monomer, dodecanoic acid was used in order to obtain an excess of dicarboxylic acid end groups. The powder was obtained by means of a precipitation process.

The melting temperature and the solution viscosity of the obtained powder were determined. The powder was then subjected to a temperature 10° C. below its melting temperature for 24 h under nitrogen and the solution viscosity continuously determined.

Melting temperature of polyamide according to example 1: 185° C.

Melting temperature of polyamide according to example 2: 185° C.

Temperature for simulation of aging: 175° C.

| | Solution viscosity | Solution viscosity |
|---|---|---|
| Time/h | Polyamide example 1 | Polyamide example 2 |
| 0 | 1.64 | 1.63 |
| 1 | 1.73 | 1.71 |
| 2 | 1.85 | 1.77 |
| 4 | 1.94 | 1.85 |
| 8 | 2.02 | 1.96 |
| 24 | 2.08 | 2.07 |

German patent application 102016219082.2 filed Sep. 30, 2016, is incorporated herein by reference.

Numerous modifications and variations on the present invention are possible in light of the above teachings. It is therefore to be understood that within the scope of the appended claims, the invention may be practiced otherwise than as specifically described herein.

1. A polyamide powder, wherein the polyamide has a solution viscosity measured according to ISO 307 of 1.55 to 1.75 and an increase in the solution viscosity of 10% to 40% when measured in a nitrogen atmosphere at a temperature of 10° C. below a melting temperature of the polyamide for 24 h.

2. The polyamide powder according to claim 1, wherein the polyamide comprises excessive amine end groups as compared to carboxylic acid end groups.

3. The polyamide powder according to claim 2, wherein the excessive amine end groups are achieved through monoamines.

4. The polyamide powder according to claim 2, wherein an excess of the amine end groups over the carboxylic acid end groups is 20 to 60 mmol/kg, based on a total mass of the polyamide powder.

5. The polyamide powder according to claim 1, wherein the polyamide comprises excessive carboxylic acid end groups as compared to amine end groups.

6. The polyamide powder according to claim 5, wherein the excessive carboxylic acid end groups are achieved through monocarboxylic acids.

7. The polyamide powder according to claim 5, wherein an excess of the carboxylic acid end groups over the amine end groups over is 20 to 60 mmol/kg, based on a total mass of the polyamide powder.

8. The polyamide powder according to claim 1, wherein the polyamide powder has a BET surface area measured according to DIN ISO 9277 of at least 1 m²/g.

9. The polyamide powder according to claim 1, wherein the polyamide powder has a weight-average particle diameter d₅₀ measured by laser diffraction of not more than 100 μm.

10. The polyamide powder according to claim 1, wherein the polyamide powder has a bulk density measured according to DIN 53466 of 300 g/l to 600 g/l.

11. The polyamide powder according to claim 1, wherein the polyamide powder has a surface energy of not more than 35 mN/m, and the surface energy is determined via a contact angle measurement by capillary rise height method using Washburn equation and an evaluation method according to Owens, Wendt, Rabel and Kaelble.

12. The polyamide powder according to claim 1, obtained by a precipitation process.

13. The polyamide powder according to claim 1, wherein the polyamide is at least one selected from the group consisting of polyamide 6, polyamide 11, polyamide 12, polyamide 1013, polyamide 1012, polyamide 66, polyamide 46, polyamide 613, polyamide 106, and polyamide 12/1012.

14. A process for preparing the polyamide powder according to claim 1, the process comprising
a) preparing the polyamide via a polymerization and/or polycondensation of monomers, and
b) preparing the powder by grinding or reprecipitation,
wherein, in a), either monoamines to achieve excessive amine end groups or monocarboxylic acids to achieve excessive carboxylic acid end groups are added as chain transfer agents.

15. The process according to claim 14, wherein
at least one AB type polyamide, produced by polymerization of at least one lactam comprising a monomer unit of 4 to 14 carbon atoms or by polycondensation of at least one corresponding ω-aminocarboxylic acid comprising a monomer unit of 4 to 14 carbon atoms, and at least one AABB type polyamide, produced by polycondensation of at least one diamine and at least one dicarboxylic acid, each having a monomer unit of 4 to 14 carbon atoms, are obtained in a), and
the powder is obtained in b) by coprecipitation of the at least one AB type polyamide and the at least one AABB type polyamide.

16. A powder bed fusion method for producing a shaped body, the method comprising:
preparing the shaped body from the polyamide powder according to claim 1.

17. A shaped body, obtained at least partly from the polyamide powder according to claim 1.
